(19) United States
(12) Patent Application Publication
(10) Pub. No.: US 2012/0284349 A1
(43) Pub. Date: Nov. 8, 2012

(54) METHOD FOR BROADCASTING A DATA STREAM AND METHOD FOR INTERACTION AMONG USERS

(76) Inventors: Julien Robinson, Nozay (FR); Johann Stan, Nozay (FR)

(21) Appl. No.: 13/509,025

(22) PCT Filed: Nov. 3, 2010
(86) PCT No.: PCT/FR10/52351

§ 371 Date: Jul. 23, 2012

(30) Foreign Application Priority Data
Nov. 10, 2009 (FR) 0905413

(51) Int. Cl. G06F 15/16

(52) U.S. Cl. 709/206

(57) ABSTRACT

The current invention pertains to a method for distributing at least one excerpt from a data stream sent or received by at least one first member of a group of users of a communication network to at least one second member of the group of users, comprising the following stages:
Detection of a data stream sent or received by said at least one first member of the group of users,
Extraction of at least a part of the data from the stream detected based on at least one parameter of the data stream,
Filtering of the data extracted based on at least one parameter corresponding to the user profile of at least one second member,
Distribution of the filtered data to said, at least one, second member of the group of users, the type of data in the flow corresponding to a voice or video message.

This invention relates to the field of telecommunication and more particularly, telecommunication among various contacts within a group.

Current means of telecommunication make it possible to communicate in various ways, by voice, in writing, by video, publicly, or privately. Nevertheless, these modes of communication tend to separate conversations (chat, VoIP, etc.) or to make them public and remove any confidentiality or privacy (blogs, Internet pages, etc.).

Therefore, while conversations or exchanges in daily life typically take place by hearing a word or expression that attracts our attention (conversations at parties, discussions around the coffee maker, etc.) or viewing a detail that provokes our curiosity (dress, behaviour of a person, etc.), current modes of telecommunication do not make it possible to reproduce these processes or only in limited fashion such as with social networking Internet sites where one can share his or her activity or mood at the time and where one can react and add his or her own comment.

Additionally, reading blogs, forums, or social networking sites can be restrictive and can require quite a lot of time to read all of the various messages.

Therefore, the goal of the current invention is to overcome the aforementioned disadvantages to the state of the art and pertains a method distributing at least one excerpt from a data stream sent or received by at least one first member of a group of users of a communication network to at least one second member of the group of users, comprising the following stages:
Detection of a data stream sent or received by said, at least one, first member of the group of users,
Extraction of at least a part of the data from the stream detected based on at least one parameter of the data stream,
Filtering of the data extracted based on at least one parameter corresponding to the user profile of at least one second member,
Distribution of the filtered data to said, at least one, second member of the group of users, the type of data in the flow corresponding to a voice or video message.

According to another aspect of the present invention, the method also comprises, after the extraction step, a step to save the extracted data.

According to an additional aspect of the present invention, the, at least one, second member may, after the distribution of the filtered data, request the distribution of additional excerpts from the data stream, these additional excerpts being obtained from the saved data.

According to an additional aspect of the present invention, the, at least one, first member and the, at least one, second member of the group of users are contacts from a directory.

According to another aspect of the present invention, the, at least one, data stream parameter corresponds to the type of data in the stream.

According to an additional aspect of the present invention, said, at least one, parameter corresponding to the user profile of said, at least one, second member is set by said, at least one, first member.

According to an additional embodiment, the method also comprises, after the extraction step, a step to process the extracted data.

According to another aspect of the present invention, data processing makes it possible to select the elements from the extracted data that meet at least one selection criterion.

According to an additional aspect of the present invention, data processing makes it possible to identify the sender and the, at least one, recipient of the data stream.

According to an additional aspect of the present invention, data processing makes it possible to select and/or modify the content of the extracted data according to at least one parameter corresponding to the user profile of the, at least one, second member.

According to an additional aspect of the present invention, said, at least one, parameter corresponding to the user profile of said, at least one, second member comprises a level of confidentiality.

According to another aspect of the present invention, said, at least one, parameter corresponding to the user profile of said, at least one, second member comprises a number of excerpts from the data stream distributed to said, at least one, second member.

According to an additional aspect of the present invention, the type of data in the stream corresponds to a voice message, a written message, or a video message.

According to an additional aspect of the present invention, the method comprises, after the step to detect a data stream, a step to detect a word or expression in the data stream, said word or expression being selected by the, at least one, second member of the user group, said detection triggering the subsequent steps in the distribution method.

The invention also pertains to an interaction method for a second member of a group of users of a communication network with at least one first member of said group comprising a distribution method in which, after receiving the data filtered by said second member, the method comprises the following steps:
Sending a request from said second member to said, at least one, first member to be placed into communication with said, at least one, first member,
Processing said request by said, at least one, first member, if the request is accepted,
Placing said second member into communication with said, at least one, first member.

The invention also pertains to a communication device comprising means configured to
Detect a data stream transmitted or received by, at least one, first member of a group of users of a communication network,
Extract at least a part of the data from the stream detected based on at least one parameter of the data stream,
Filter the data extracted based on at least one parameter corresponding to the user profile of at least one second member of the user group,
Distribute the filtered data to said, at least one, second member of the group of users, the type of data in the stream corresponding to a voice or video message.

According to another aspect of the present invention, the means are also configured to save the content of the extracted data.

According to an additional aspect of the present invention, the means of detecting a data stream transmitted or received by, at least one, first member and of extracting the corresponding data are configured to operate with an Internet Protocol (IP) Multimedia Subsystem (IMS) architecture.

This method therefore makes it possible to extract data transmitted or received by a user and to distribute them to his or her contacts while respecting the privacy of the various users. Moreover, the method makes it possible for the contacts receiving an excerpt of the data exchanged to easily enter into communication with the person or persons who exchanged these data in order to make a contribution.

Other characteristics and benefits of the invention will become apparent from the following description, given with reference to the attached drawings, which by way of a non-limiting example depict one possible embodiment.

In these drawings:

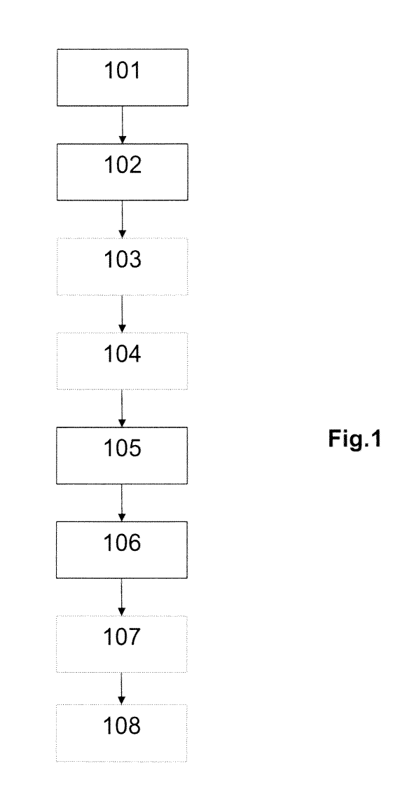

FIG. 1 depicts a block diagram of the various steps of one embodiment of the present invention;

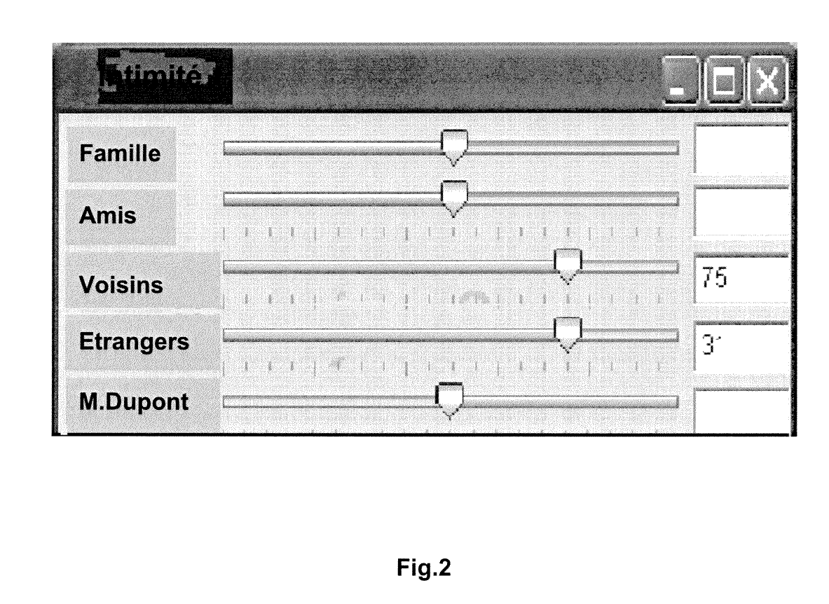

FIG. 2 depicts a diagram of a configuration window for a privacy parameter for contact sub-groups;

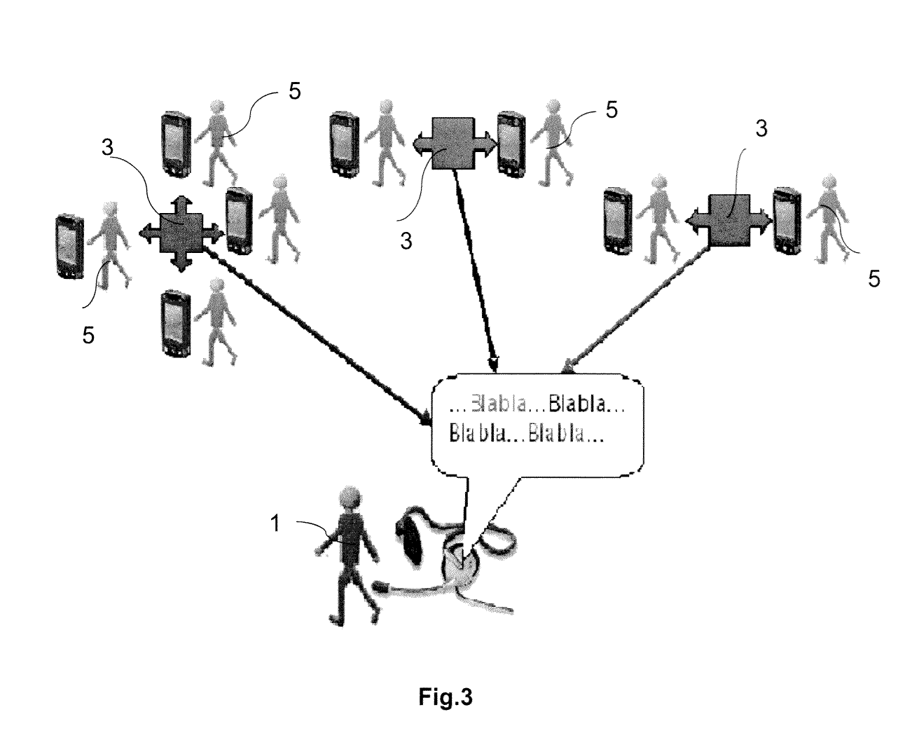

FIG. 3 depicts the reception of excerpts of three conversations involving at least one first member of a group of contacts by a second member of the group of contacts;

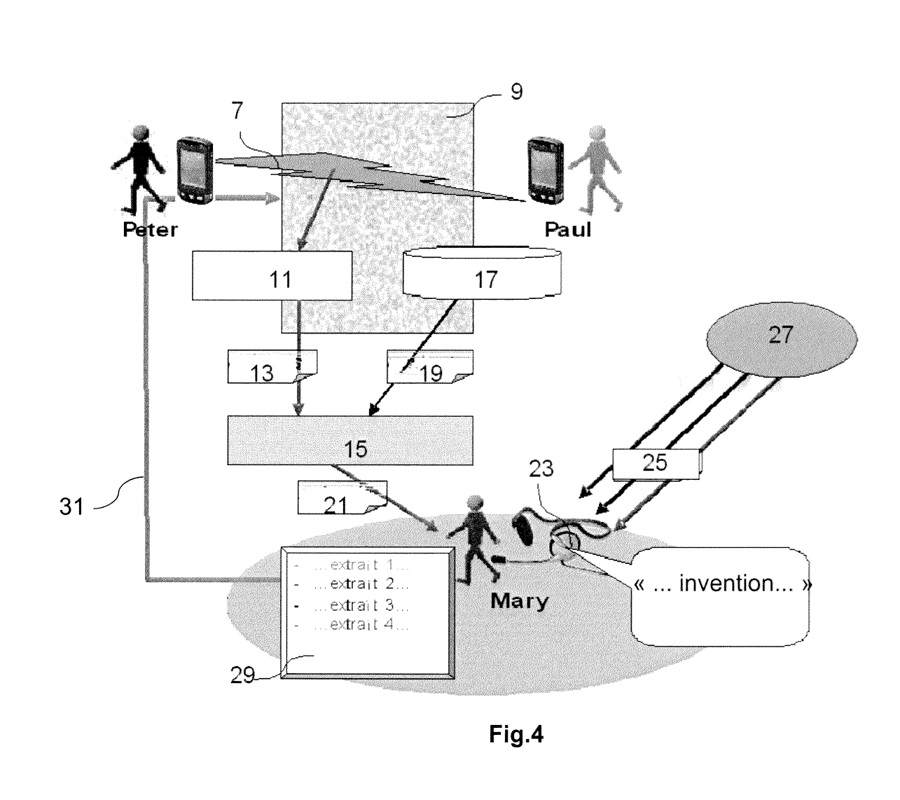

FIG. 4 depicts an example of an embodiment of a method for distributing excerpts of conversations according to the present invention.

In the following description, generally:

The term data “type” corresponds to the mode of communication corresponding to these data. The data can be, for example, voice if they correspond to an oral message or written if they correspond to a written message, for example, an email, a message posted in a discussion forum, etc. Moreover, the mode of transmission or reestablishment of the data may constitute a data type, for example, written data intended for instant messaging.

The term “VoIP” is the English acronym Voice over Internet Protocol and corresponds to the transmission of voice message over the Internet.

The term “SMS” is the English acronym Short Message System and corresponds to short text messages, also called mini-messages.

The term “IMS” is the English Acronym Internet Protocol (IP) Multimedia Subsystem and corresponds to a standardised architecture making it possible to provide fixed and mobile multimedia services;

The embodiments of the present invention pertain to a group of users of a communication network, the group corresponding to contacts in a directory and comprising, for example, friends, family members, members of an association, or professional contacts.

To make it possible for the users to understand the topics of conversation or the business of their contacts, monitoring of the various exchanges or comments is carried out and excerpts of these exchanges or comments are sent to the various contacts who requested the distribution of these excerpts.

It should be noted that the user may only receive excerpts of conversations from another user if the other user is one of the contacts in his or her directory.

In order to implement such a method, various steps are necessary as described in FIG. 1.

The first step 101 pertains to the detection of a data stream transmitted or received by at least one first member of the group of users. For example, these data may correspond to:
A voice message sent by telephone or VoIP;
A video conference message sent over the Internet;
A written message corresponding to an email or an SMS message;
A written instant message;
A written, voice, or video message posted on a blog, on the wall of a social networking site, or an Internet page;
A video message sent over the Internet;
An image sent over the Internet;

The second step 102 pertains to the extraction of data from the stream detected in step 101. The extraction may be partial or complete and can be adapted to the data type and format. Moreover, the extraction may be selective, such that if a data stream corresponds to a conversation between two persons, the extraction may only pertain to the words of one of the two people. For example, in cases where only one of the two persons accepted the distribution of excerpts. Therefore, in the case of a telephone conversation, voice recognition software may be used to filter out the words of some participants.

Optional step 103 pertains o saving the data extracted in step 102. This recording may be temporary (placed in a memory buffer) or permanent (until erased from the corresponding memory or until a predetermined action occurs (the related software is closed, etc.)).

Optional step 104 pertains to processing the data extracted in step 102. This processing is designed to analyse the extracted data so as to determine the relevant information from among all of the data, for example a word, an expression, or an image.

Various processing parameters may be taken into account in processing the data according to a selected configuration:
The data format: a conversion of the data format may be carried out if necessary in order to be re-transcribed for a second user, for example a voice message may be converted into a written message, or a written message may be converted into a voice message. Thus, any type of conversion may be carried out.
The size of the excerpt: the size corresponds to the length of the text for a written excerpt or the duration in the case of an image, voice, or video excerpt.
The identification of the sender or recipients of the data stream and the persons cited in the excerpt. Thus, the content of the excerpt may degrade, limit, or improve the identification of the various persons linked with the message. For example, the names of the persons may be hidden or replaced by pronouns, and vice versa.

These various processing parameters may be adjusted according to the profile of the second member to whom the excerpt is sent. Thus, various combinations of excerpts may be created from a single data stream. Moreover, the profile of the second member may depend on confidentiality and privacy parameters selected by the first user. Thus, the contacts of the first user who constitute potential second members, designated to receive message excerpts, may be grouped into sub-groups for which privacy levels may be adjusted, for example, by moving cursors as depicted in FIG. 2. Thus, a high level of privacy may correspond for example to a shorter excerpt and/or to masking identities. The adjustment of one or more parameters of the user profile of a second member may also be carried out on an individual basis.

Step 105 corresponds to data filtering. This filtering corresponds, among the extracted or processed data, to the selection of what is retransmitted to the second member. Thus, the second member may adjust the duration and frequency of the excerpt or excerpts that he or she receives. Thus, if he or she receives excerpts of several messages, the second member may decide to reduce the duration of message excerpts that he or she deems less interesting.

It should be noted that steps 102, 104, and 105 may be combined and carried out by a single extraction and processing unit. Moreover, the order of these steps may be modified in relation to this description.

Step 106 corresponds to the distribution of the excerpt to the second member. Depending upon the format of the excerpt, the distribution may correspond to audio and/or visual distribution. Additionally according to one aspect of the present invention, the first member may, at any time, suspend the distribution of excerpts to a contact, a group of contacts, or all contacts. The latter will then be notified by a distribution stop message.

Optional step 107 corresponds to the selection of an excerpt by the second member. For example, a conversation excerpt contains a word or expression that attracts the attention or curiosity of the second member. He or she then selects the word or expression in order to receive additional excerpts or longer excerpts of the corresponding conversation.

Additionally, if the embodiment contains step 103, the second member may, when he or she selects an excerpt, obtain the distribution of additional or longer excerpts, these excerpts being obtained from the saved data. Nevertheless, access to the details of the conversation may be restricted according to the user profile of the second member.

Optional step 108 corresponds to placing the second member into communication with the first member and his or her potential communication partners. Following the distribution of excerpts, the second member may ask to be placed into communication with the first member who transmitted a conversation. The way the conversation is joined may vary according to the type of the initial conversation involving the first member from which the excerpt was obtained.

Moreover, if there are various possibilities for joining a conversation, the second member may be given a choice for selecting a mode of communication. Thus, if the initial conversation is a telephone conversation between two persons, the second member may send a request to carry out a three-way telephone conversation. The first member and potentially his or her conversation partner or partners then receive the request. The first member may then accept the request and thus initiate a three-way conversation or refuse and then continue the two-way conversation.

Moreover, the request may also be sent to the conversation partners of the first member so that they can choose whether or not to approve access to the conversation by the second member.

Additionally, a single contact corresponding to a second member 1 may receive excerpts from several conversations 3 corresponding to several of his or her contacts (which in this case are the first members 5) as depicted in FIG. 3. In this case, the conversations 3 correspond to telephone conversations and the second member alternately or sequentially receives excerpts from the various conversations 3. The number of conversations 3 is not limited but may potentially influence the duration and frequency of the various excerpts distributed.

In order to better understand the invention, an example of an embodiment will now be described in detail.

Mary, Paul, and Peter are members of a group of users of a communication network. Moreover, Mary is one of Peter's contacts. Thus, with their authorisation, Peter's conversations may be detected, monitored, and redistributed (partially, or in their entirety, raw or processed as described above) to Mary (and conversely Mary's conversations to Peter) as well as to Peter's other contacts. These conversations correspond to the data streams described above.

FIG. 4 depicts a diagram of the device in which Peter and Paul are in conversation 7, for example a voice conversation transmitted by VoIP and managed by an IMS (IP Multimedia Subsystem) architecture 9. Mary was informed of a conversation involving Peter and selected this conversation to receive excerpts from it.

Peter and Paul are then notified that excerpts of their conversation are being sent to Mary (they can then block redistribution to Mary at any time).

A conversation analysis and extraction unit 11 makes it possible to recover and select where necessary the data corresponding to the conversation between Peter and Paul. Conversation excerpts 13 are then sent to a distribution service 15. The distribution service 15 is also connected to a contact list 17 and can therefore receive information on the identity and user profiles of Peter and Paul's contacts (Mary among others in this case).

Thus, from the extracted data and the user profiles, the distribution service 15 can adapt the excerpts 21 distributed to Mary according to her user profile. This adaptation may range from the selection and duration of the excerpts distributed to data processing (for example by selecting only excerpts corresponding to Peter's voice by using voice recognition software).

Mary then listens to the excerpts 21 of the conversation between Peter and Paul through her headphones 23. Additionally, Mary decided to receive excerpts 25 of other conversations 27. Thus, the various voice excerpts are distributed in alternating or sequential fashion to her headphones 23 while any potential written excerpts are displayed on her computer screen. If Mary only follows voice conversations, Mary can carry out another activity while following the conversations of her contacts. Moreover, listening may take place through a portable computer or a telephone which makes it possible for Mary to follow the conversations from any location.

Additionally, a window 29 on her computer (or telephone) contains a link to the various conversations so that Mary can request additional information about the conversation between

Peter and Paul or be placed into communication with Peter and Paul.

In this example, the word “invention” in the conversation between Peter and Paul a tracts Mary's attention, she then selects the conversation on her computer and requests the complete distribution of the latest excerpts to precisely determine the context of the conversation. The complete sentence is then redistributed: “Peter has a new invention and wants to patent it”. This topic interests Mary, who selects the conversation between Peter and Paul, and with a single click, sends a request 31 to Peter and Paul, through the IMS architecture 9, in order to participate in the conversation. Peter and Paul are then asked to authorise Mary to participate in the conversation. After acceptance, a three-way telephone conference between Peter, Paul, and Mary is then automatically established.

The embodiments of the present invention therefore make it possible to select excerpts of conversations and to distribute these excerpts to contacts of the communicators so that they can understand the topics of the conversations. Thus, this makes it possible to virtually recreate what takes place at a party among friends or in conversations among colleagues during a break where perception of a word or expression attracts our attention and pulls us into the conversation. Moreover, the privacy and confidentiality of the conversations are respected through processing of the data extracted from the conversations, the selection of very brief excerpts, or the ability to suspend the distribution of excerpts at any time. With the present invention, the person receiving the distribution of excerpts can therefore easily enter into communication with the various conversation partners involved in the excerpts. Additionally, the embodiments of this invention can be adapted to any conversation type and therefore make it possible to facilitate communication within a group of contacts and make it possible for each user to contribute to the topic of a conversation, an exchange, or a piece of information sent by one of his or her contacts. Lastly, by selecting excerpts, the embodiments described make it possible to monitor several conversations at the same time while carrying out another activity.

1. A method for distributing at least one excerpt from a data stream sent or received by at least one first member (5) of a group of users of a communication network to at least one second member of the group of users, comprising the following stages:
Detection by a communication device of a data stream sent or received by said, at least one, first member (5) of the group of users (101),
Extraction by a communication device of at least a part of the data from the stream detected based on at least one parameter of the data stream (102),
Filtering by a communication device of the data extracted based on at least one parameter corresponding to the user profile of at least one second member (1) (104),
Distribution, by a communication device, of the filtered data to said, at least one, second member (1) of the group of user (105), the type of data in the stream corresponding to a voice or video message.

2. Distribution method according to claim 1 also comprising, after the extraction step, a step to save the extracted data.

3. Distribution method according to claim 2 in which the, at least one, second member may, after the distribution of the filtered data, request the distribution of additional excerpts from the data stream, these additional excerpts being obtained from the saved data.

4. Distribution method according to claim 1 in which the, at least one, first member and the, at least one, second member of the user group are contacts in a directory.

5. Distribution method according to claim 1 in which said, at least one, parameter of the data stream corresponds to the type of data in the stream.

6. Distribution method according to claim 1 in which said, at least one, parameter corresponding to the user profile of said, at least one, second member (1) is set by said, at least one, first member (5).

7. Distribution method according to claim 1 also comprising, after the extraction step, a step to process the extracted data (103).

8. Distribution method according to claim 7 in which data processing makes it possible to select the elements from the extracted data that meet at least one selection criterion.

9. Distribution method according to claim 7 in which data processing makes it possible to identify the sender and the, at least one, recipient of the data stream.

10. Distribution method according to claim 7 in which data processing makes it possible to select and/or modify the content of the extracted data according to at least one parameter corresponding to the user profile of the, at least one, second member (1).

11. Distribution method according to claim 1 in which said, at least one, parameter corresponding to the user profile of said, at least one, second member (1) corresponds to a level of confidentiality.

12. Distribution method according to claim 1 in which said, at least one, parameter corresponding to the user profile of said, at least one, second member (1) comprises a number of distributions of excerpts from the data stream to said, at least one, second member (1).

13. Distribution method according to claim 1 that comprises, after the step to detect a data stream, a step to detect a word or expression in the data stream, said word or expression being selected by the, at least one, second member (1) of the user group, said detection triggering the following steps in the distribution method.

14. Method for a second member (1) of a group of users of a communication network to interact with at least one first member (5) of said group comprising a distribution method in which after receiving the data filtered by said second member, the method comprises the following steps:
Sending a request from said second member (1) to said, at least one, first member (5) to be placed into communication with said, at least one, first member (5) (106),
Processing said request by said, at least one, first member (5), if the request is accepted,
Placing said second member (1) into communication with said, at least one, first member (5) (107).

15. Communication device comprising means configured to
Detect a data stream transmitted or received by, at least one, first member (5) of a group of users of a communication network,
Extract at least a part of the data from the stream detected based on at least one parameter of the data stream,
Filter the data extracted based on at least one parameter corresponding to the user profile of at least one second member (1) of the user group,
Distribute the filtered data to said, at least one, second member (1) of the group of users, the type of data in the stream corresponding to a voice or video message.

16. Communication device according to claim 15 in which the means are also configured to select and/or modify the content of the extracted data according to at least one parameter corresponding to the user profile of the, at least one, second member (1).

17. Communication device according to claim 15 in which the means of detecting a data stream transmitted or received by at least one first member (5) and of extracting the corresponding data are configured to operate with an Internet Protocol (IP) Multimedia Subsystem (IMS) architecture.
